(19) United States
(12) Patent Application Publication
(10) Pub. No.: US 2009/0216452 A1
(43) Pub. Date: Aug. 27, 2009

(54) ENERGY RECOVERY WITHIN A FLUID DISTRIBUTION NETWORK USING GEOGRAPHIC INFORMATION

(75) Inventors: David Nance, Austin, TX (US); Perry Bushong, San Antonio, TX (US)

Correspondence Address: FULBRIGHT & JAWORSKI L.L.P., 600 CONGRESS AVE., SUITE 2400, AUSTIN, TX, 78701, US

(73) Assignee: DEVELOP TECH RESOURCES, Austin, TX (US)

(21) Appl. No.: 11/994,749

(22) PCT Filed: Jul. 3, 2006
(86) PCT No.: PCT/US2006/026065

§ 371 Date: Nov. 3, 2008

Related U.S. Application Data
(60) Provisional application No. 60/696,674, filed on Jul. 5, 2005.

(51) Int. Cl. G06F 19/00; G06Q 10/00; G06Q 50/00

(52) U.S. Cl. 702/5; 705/7

(57) ABSTRACT

Systems and methods for capturing and making use of excess and/or wasted energy within fluid distribution networks are disclosed. In particular, a process for identifying a location within a network where energy is otherwise dissipating or wasted is disclosed. Geographical information is accessed for determining location(s) within the fluid distribution network suited for energy capture. Once the location(s) is identified, an appropriate power recovery system(s) suited for each location is determined. Captured energy can be used within the fluid distribution network, outside of the fluid distribution network, and/or stored for future use.

This patent application claims priority to, and incorporates by reference in its entirety, U.S. Provisional Patent Application Ser. No. 60/696,674 filed on Jul. 5, 2005, entitled, “Energy Recovery Within a Fluid Distribution Network Using Geographical Information,” by Bushong et al.

### BACKGROUND OF THE INVENTION

1. Field of the Invention

The invention relates generally to the field of energy generation. More particularly, it involves techniques for using geographical information to identify locations within a fluid distribution network for installation of a device configured to capture excess or otherwise wasted energy.

2. Description of Related Art

The most common energy supply used for personal, commercial, and defense purposes comes from sources such as fossil fuels and natural gas and fuels. However, the finite supplies of these conventional energy sources are being depleted due to increased processing and consumption. As such, alternative energy sources are being relied upon and developed to meet the current demand. One example of an alternative energy source is nuclear power. Nuclear power can come from the fission of uranium, plutonium, thorium or the fusion of hydrogen into helium and can provide upwards of a few million kilowatt of energy using one reactor. However, the conversion of nuclear power is often unacceptable, not only because construction and maintenance costs are enormous, but also because the technologies in managing radioactive wastes and in preventing a disastrous incident of core meltdown have been uncertain and, therefore, unreliable.

Another energy source currently being used is hydropower, where the force of moving water can generate power. Generally, hydraulic power plants are used to capture this energy source. Examples of hydraulic power plant designs are dams that have the potential to produce hundreds of megawatts of electrical power. While such capital intensive projects can be one of the most reliable sources of power available, expansions or new development of such projects can have a negative impact on the environment. Even smaller scale hydraulic power plants, such as those used in manufacturing plants, can be impractical due to environmental restrictions, lack of efficiency in small hydro technologies, seasonal flow variations, and the logistical difficulty of placing small hydroelectric generators in remote locations that are far away from an electric grid. Regulatory, logistical, and environmental concerns can also act as barriers to the development of natural hydraulic resources, such as offshore capturing of power from tidal movements or ocean currents. Overall, natural hydraulic power sources represent a huge potential source of power that unfortunately require extensive capital investment and can pose a risk to the environment.

One alternative energy source captures and/or recycles energy produced in a fluid distribution network such as water, gas, oil, or sewage pipeline infrastructure. The energy captured in these networks may not add any additional environmental impact to a given site as compared to hydropower systems. Also, these networks are usually located in populated areas that not only have high energy demand, but also have access to electrical grid infrastructures. Further, these networks tend to use vast amounts of energy internally, and therefore, by recycling energy, the cost of maintaining these networks decreases. However, there are several problems associated with recovering excess energy within a network. For example, most fluid distribution networks are part of a complex infrastructure, which makes it extremely difficult to identify locations for energy capture using manual engineering techniques. Also, the static water pressure at any given point throughout the network can vary considerably, which may hinder the ability to identify key areas of excess pressure within the network.

There have been several attempts in the past to capture the excess energy within a fluid distribution network, such as those described in U.S. Pat. Nos. 4,731,545, 4,496,845, 4,918,369, 5,007,241, 4,352,025, 4,488,055 and WIPO Patent No. 03/083290, each incorporated herein by reference. While these disclosures may represent useful methods for generating power within a pipeline or fluid conduit, they do not address at least the problem of finding optimal location(s) within a fluid distribution network for capturing energy.

Any shortcoming mentioned above is not intended to be exhaustive, but rather is among many that tends to impair the effectiveness of previously known techniques for capturing and/or recycling energy in a fluid distribution network; however, shortcomings mentioned here are sufficient to demonstrate that the methodologies appearing in the art have not been satisfactory and that a significant need exists for the techniques described and claimed in this disclosure.

### SUMMARY OF THE INVENTION

The present disclosure provides for, among other things, identifying locations within a fluid distribution network to place components that generate energy from fluid flow and thus may greatly aid in satisfying unmet and increasing energy needs.

In one respect, the invention involves a computer readable medium comprising instructions for retrieving geographical information associated with a fluid distribution network. The computer readable medium can provide instructions for using the geographical information to calculate energy recovery values at different locations within the fluid distribution network. In one embodiment, the computer readable medium may provide instructions to calculate a cost/benefit analysis. Alternatively, the computer readable medium may provide instructions to calculate the costs associated with placing a generator in a location within the fluid distribution network.

The computer readable medium may also provide instructions for identifying one or more optimal locations within the fluid distribution network to place a power recovery system for recovering energy based on the calculations. The type of power recovery system may be determined by the computer readable medium. In some embodiments, the type of power recovery system may be based on peak demand or head pressure demand at a location within the fluid distribution network.

In another respect, the invention involves a method. The method includes steps for retrieving geographical information associated with a fluid distribution network. Using the geographical information, one or more calculations may be performed to determine the energy recovery value at different locations within the fluid distribution network. The calculations may provide for identifying one or more locations within the fluid distribution network to place a power recovery system. The energy recovered may be used to within the fluid distribution network to pump fluids. Alternatively, the energy recovered may be used outside of the fluid distribution network. For example, the energy recovered may be stored and may be transferred for future use.

In another respect, the invention involves a system. The system may include a fluid distribution network and a computer. The computer may be configured to retrieve geographical information associated with the fluid distribution network. Using the geographical information, the computer may calculate and determine the energy recovery value at different locations within the fluid distribution network. The computer may use the calculations to identify one or more locations within the fluid distribution network to place a power recovery system. The energy recovered may be allocated to the fluid distribution network via a routing system. Alternatively, the energy recovered may be stored at an energy storage facility.

As used herein, the term “power recovery system” refers to one or more, or a combination of one or more systems, apparatuses, machines, devices, contraptions, mechanisms, and/or gadgets, that may extract and convert energy from fluid flow to recover energy that would otherwise be wasted. A power recovery system may also, in some embodiments, directly utilize the energy for various tasks, transfer the energy (e.g., to a grid), distribute the energy (e.g., to a residence), and/or store the energy (e.g., in a battery or other device).

A fluid distribution network, as used herein, includes a system of pipelines, channels, conduits, and other components necessary to transfer a fluid from one location to another. For example, a distribution network may be used in many cities to deliver water from at least one reservoir to its residents via pipelines, channels, and conduits connected to individual buildings, personal residences, etc.

Geographical information, as used herein, refers to data related to the spatial location and attributes of a fluid distribution network. Additionally, geographical information may also refer to any information related to the demographics, topography, zoning, emergency equipment, or local utility infrastructure data associated with a fluid distribution network.

Energy recovery values, as used herein, refer to data relevant to the capturing of excess or wasted energy in a fluid distribution network. In one embodiment, energy recovery values may include magnitude of energy (e.g., potential, kinetic, molecular, etc.), the available energy in the fluid distribution network, and/or the total amount of energy (e.g., head). In other embodiments, energy recovery values may include component selections for power generation that may be used to capture the excess or wasted energy. Additionally, energy recovery values may include simulation results or impact analysis of selected components within a fluid distribution network. Alternatively or in addition to the above, energy recovery values may include economic analysis, including, without limitation, project cost, economic benefits, and other financial analysis. One of ordinary skill in the art would recognize that the energy recovery values may include some or all of the above values. Alternatively, the energy recovery values may include other data that may affect the capturing of excess or wasted energy in a fluid distribution network.

An optimal location, as used herein, refers to a location determined to efficiently capture excess or wasted energy based on energy recovery values.

As is known in the art, computer readable medium may include, without limitation, a computer file, a software package, a hard drive, a floppy, a FLASH device, a CD-ROM, DVD, a hole-punched card, an instrument, an ASIC, firmware, a “plug-in” for other software, web-based applications, RAM, ROM, or any other type of computer readable medium.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other embodiments, features, and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 is a schematic diagram of a system for accessing geographical information and analyzing the data to determine at least one location to capture excess energy, in accordance with embodiments of this disclosure.

FIG. 2 is a flow chart showing steps of a computerized method, in accordance with embodiments of this disclosure.

FIGS. 3A-3C show locations for capturing excess energy using geographical information, in accordance with embodiments of this disclosure.

FIG. 4 is a graph showing an elevation profile of a fluid distribution network, in accordance with embodiments of this disclosure.

FIG. 5 is a graph showing pressure points at different distances of a fluid distribution network, in accordance with embodiments of this disclosure.

FIG. 6 is a graph showing the hydraulic head at different distances of a fluid distribution network, in accordance with embodiments of this disclosure.

FIG. 7 is a graph showing hydropower potential at different distances of a fluid distribution network, in accordance with embodiments of this disclosure.

FIG. 8 is a graph comparing an elevation profile and hydropower potential of a fluid distribution network, in accordance with embodiments of this disclosure.

### DETAILED DESCRIPTION OF ILLUSTRATIVE EMBODIMENTS

The description below is directed to specific embodiments, which serve as examples only. Description of these particular examples should not be imported into the claims as extra limitations because the claims themselves define the legal scope of the invention. With the benefit of the present disclosure, those having ordinary skill in the art will comprehend that techniques claimed and described here may be modified and applied to a number of additional, different applications, achieving the same or a similar result. The attached claims cover all such modifications that fall within the scope and spirit of this disclosure.

The average household of 3 people consumes about 10 kilowatts (kW) per day while using around 500 gallons of water in the same time period. Commercial and manufacturing entities require even higher water demand, resulting in massive amounts of water flowing through countless pipelines at high pressures controlled using various pumps, valves, and gates distributed throughout the network. Within these fluid distribution networks, there are locations that vary in excess pressure and energy due to many factors. For example, a change in elevation in the fluid distribution network can accelerate the fluid, e.g., increase the momentum of the fluid flow due to gravity. Artificial pumping, such as using electricity to run a pump, can also increase the pressure and the flow rate of the fluid. The temperature of the fluid may also affect the flow of the fluid. For example, the use of positive thermal transfer, e.g., heating the fluid in the network, can increase the potential energy of the fluid, thereby causing excessive pressure. Other factors, such as distance from pumping stations, changes in flow rate, and/or the amount of fluid in the system can also affect the pressure and energy in a fluid distribution network. The excess pressure and energy due to any one or a combination of the above, where the pressure of the fluid exceeds a threshold, may threaten the integrity of the network infrastructure and/or the quality of the service to the end-user. Threatened areas generally include control valves and regulators that are configured to dissipate the excess force. However, at these and other locations, the excess energy can be captured and/or recycled, and may be utilized to generate energy.

Using geographical information about a fluid distribution network and its surroundings including, for example, terrain elements in which the infrastructure is laid out, allows one to identify one or more locations within the fluid distribution network where energy can be captured. In one embodiment, the geographical information may come from a geographical information system (GIS). Generally, the GIS may include a layered data structure where attributes and data points on each layer map to a coordinate system. In one embodiment, the geographical information may be stored in electronic form (ESRI shape files, ArcGIS filesCAD files, databases, or spreadsheets). Alternatively, the geographical information may be printed or written data found in maps, almanacs, or other sources.

Geographical information about a fluid distribution network may include data on the spatial location of network components such as pipes, valves, storage facilities, pumps, and meters. Other attributes of network components including, but not limited to, the type of material, dimensions, elevations, hydraulic grade lines (HGL), energy grade line (EGL), static or dynamic pressure, age, condition, and capacity may also be included.

Alternatively or in addition to the above, in some embodiments, other geographical data may also be used. For example, the demographics, topography, zoning, emergency equipment, and local utility infrastructure data may be used to determine optimal locations to capture excess energy. These variables may be used to calculate current and future demand, loads on the system, or to ensure that any changes or additions to a system do not interfere with requirements for fluid quality, service quality, public safety, or emergency facilities, e.g., minimum hydrant pressure and flow.

In some embodiments, the geographical information data may be converted into a format that can be interpreted by a software program. The software may optimize the data by removing redundant or unwanted information and correcting for errors. In one embodiment, the software may embody an automated process for identifying location(s) for capturing energy in a fluid distribution network. The software may determine a magnitude of energy within the fluid distribution network. The total energy in a given network may be the sum of the potential energy, kinetic energy, molecular forms of energy, and/or other forms of energy in the system. For example, for hydraulic system analysis, the total amount of energy or head usually refers to the sum of velocity head (V²/2 g), elevation head (Z) and pressure energy (P/γ) expressed in head feet or meters (H). The total head may be expressed as follows:

$$H = z + \frac{p}{γ} + \frac{{V}^{2}}{2 g} \qquad Eq . 1$$

where H is the total head (measured in meters or feet), z is the elevation above datum (measured in meters or feet), p is the pressure (measured in N/m² or lb/ft²), γ is the specific weight of the fluid (measured in N/m³ or lb/ft³), V is the fluid velocity (measured in m/s or ft/s), and g is the gravitational acceleration (measured in m/s² or ft/s²).

If the specific head is calculated along various points in the fluid distribution network, an energy grade line (EGL) may be generated. The software may subsequently use the calculated EGL to locate peaks or highest total energy points throughout the fluid distribution network.

In another embodiment, the software may determine the energy available for work (in kilowatts, kW) at various locations in the network. The power available for extraction may be estimated by using the available head from, for example, using Eq. 1, along with information on the amount of flow through the fluid distribution network and the minimum head that needs to be maintained for quality of service downstream. If a loss of power available is determined due to imperfect generator efficiency or energy loss within the fluid distribution network (e.g. pipe loss due to friction), the following equation may be used to estimate the potential hydraulic power available at a given point:

$$P = \frac{( H - {H}_{m i n} ) Q}{κ} \qquad Eq . 2$$

where P is the available power in kilowatts, H is the total head in feet, Hₘᵢₙ is the minimum head needed to maintain downstream use, Q is the flow in cubic feet per second, and κ is 11.8, a constant for conversion to kWatts. If these same calculations are applied to every point, or a multitude of points, in a given fluid distribution network, the resulting data may provide a detailed representation of the energy available for extraction throughout the fluid distribution network. The software may be able to sort the data and quickly identify points with a high potential for useful power generation.

After one or more locations have been identified, the software may begin the process of component selection for power generation. For a conventional hydraulic power recovery system, there are at least three basic components: a turbine, a generator, and power conversion equipment. The turbine converts kinetic energy of the fluid into rotational power in a shaft. This rotational power can be used to do work directly in mechanical form or operate a generator to produce electricity. Typically, a turbine is designed for specific conditions of flow, such as the amount of fluid moving through a specific location and head, e.g., a measure of the change in elevation of a fluid as it moves through the network.

There are at least two main categories of turbines that may be used: impulse and reaction. Impulse turbines use a nozzle at the end of a pipeline to convert a fluid under pressure into a high powered jet. The kinetic energy of the jet is transferred to the runner of the turbine. One example of an impulse turbine includes a pelton turbine which can typically be used for high head locations (approximately 50 to 6,000 feet). Other examples of impulse turbines include turgo turbines and cross-flow turbines. Reaction turbines generally convert the energy of the fluid from pressure to shaft rotation within the turbine wheel itself. One example of a reaction turbine includes a Francis turbine. The Francis turbine includes a runner with fixed vanes in which the fluid enters the turbine in a radial direction with respect to the shaft. Francis turbines are designed for low-head (approximately 10-2000 feet) situations. Another example of a reaction turbine is a propeller turbine which can be used for very low head (approximately 10-300 feet) situations.

Generator selection may be determined by efficiency and type of power needed, e.g., high voltage AC/DC, low voltage AC/DC, or high/low frequency. Power conversion equipment may be determined by the end user of the power. Power that may be used on site, e.g., recycled and redistributed within the fluid distribution network may require extra equipment beyond simple safety and regulating components. Power that may be stored for later use may require batteries. Power that may be fed directly to the power grid or transported elsewhere may require additional transformers and regulators to maintain a consistent level of performance. Efficiency, reliability, and cost may be the selection criteria for all such components and may be customized for individual networks. One of ordinary skill in the art would recognize the additional components required for each of the above embodiments.

In one embodiment, the software may perform further analysis by running a simulation or impact analysis of any selected configuration. This analysis may identify conflicts with other infrastructure in the area, eliminate safety concerns, and test performance based on future demand projections.

Software for implementing techniques of this disclosure may also include a comprehensive economic analysis. Using established guidelines and user input, the software may give an accurate estimate of project cost and estimate the economic benefits of the project such as revenue generated through the sale of electricity generated or overhead reduction due to internal use of the power. Other traditional financial analyses such as break- even point or net present value may be used to help the user make a final decision on the project.

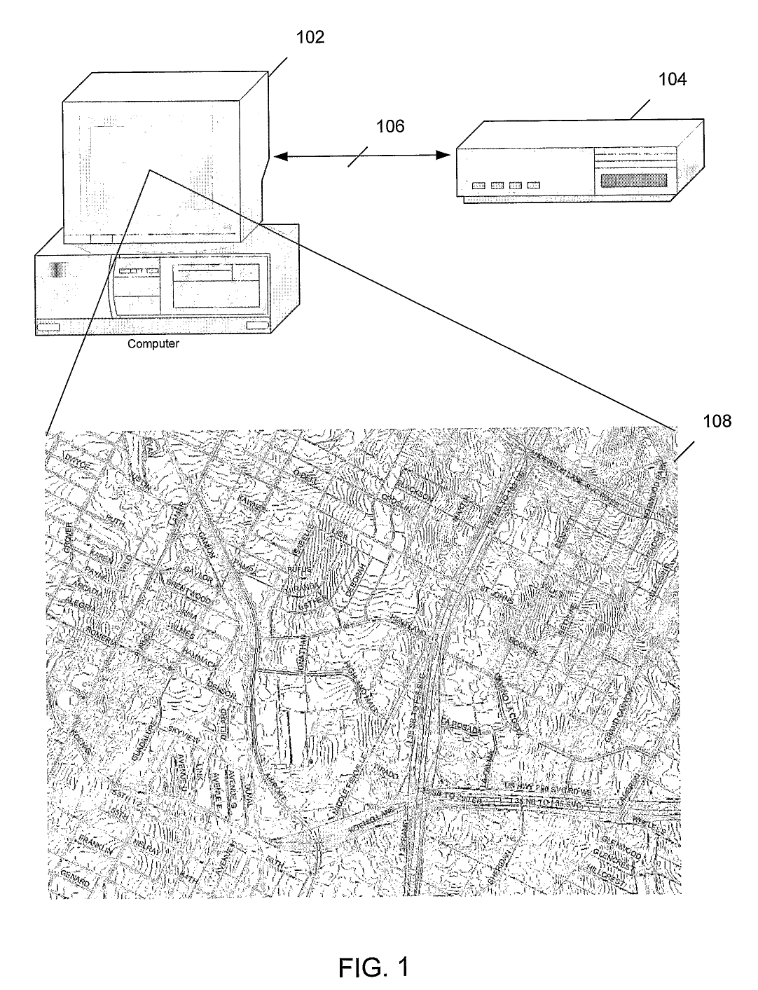

In one embodiment, referring to FIG. 1, computer 102 may be used to run software discussed above. The software program can be embodied on any computer-readable media known in the art. For example, it may be embodied internally or externally on a hard drive, ASIC, CD drive, DVD drive, tape drive, floppy drive, network drive, flash, or the like. Computer 102 is meant to indicate any computing device capable of executing instructions for accessing geographical information and analyzing the information to determine location(s) within a fluid distribution network to capture energy, among other things. In one embodiment, computer 102 is a personal computer (e.g., a typical desktop or laptop computer operated by a user). In another embodiment, computer 102 may be a personal digital assistant (PDA) or other handheld computing device.

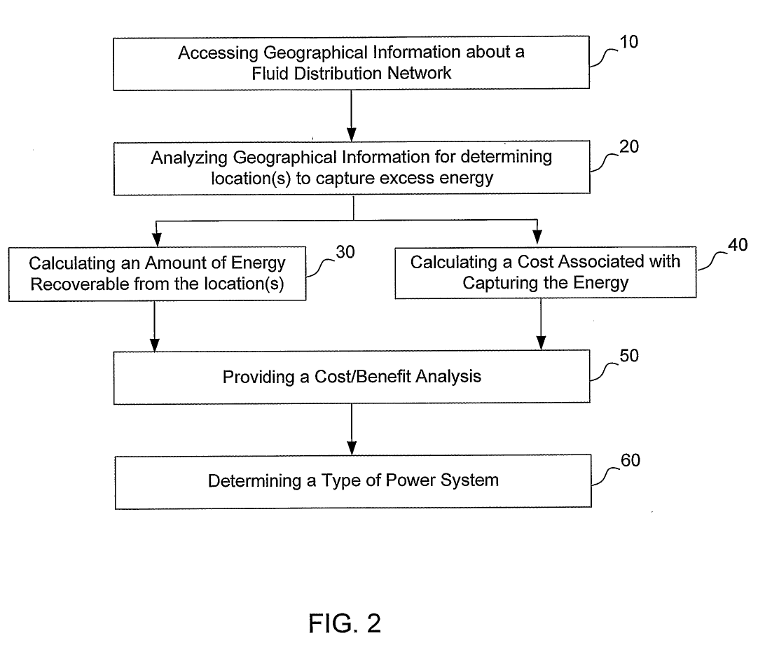

The software for carrying out steps disclosed here can be written according to any technique known in the art. For instance, the software may be written in any one or more computer languages (e.g., ASSEMBLY, PASCAL, FORTRAN, BASIC, C, C++, C#, JAVA, etc.), adapted to provide instructions for carrying out the steps in, for instance, FIG. 2.

In one embodiment, computer 102 may be coupled to database 104, via connection 106. Connection 106 is meant to indicate any connection suitable for allowing computer 102 to communicate database 104. In one embodiment, connection 106 is a wired connection. In another embodiment, connection 106 is wireless. In some embodiments, connection 106 may be a network connection over a network such as the Internet. Such an embodiment allows for accessibility to databases storing geographical information from virtually any computer in the world connected to the Internet. In another embodiment, computer 102 and database 104 are integral. In such an embodiment, connection 106 may be an internal connection.

Computer 102 can be a networked device and may constitute a terminal device running software from a remote server, wired or wirelessly. Input from a user may be gathered through one or more known techniques such as a keyboard and/or mouse. Output, if necessary, can be achieved through one or more known techniques such as an output file, printer, facsimile, e-mail, web-posting, or the like. Storage can be achieved internally and/or externally and may include, for example, a hard drive, CD drive, DVD drive, tape drive, floppy drive, network drive, flash, USB, or the like. Computer 102 may use any type of monitor or screen known in the art, for displaying information, such as but not limited to, geographical information 108. For example, a cathode ray tube (CRT) or liquid crystal display (LCD) can be used. One or more display panels may also constitute a display. In other embodiments, a traditional display may not be required, and computer 102 may operate through appropriate voice and/or key commands.

FIG. 2 is a flow chart showing example steps of a method for using geographical information to identify location(s) within a fluid distribution network for capturing energy, in accordance with embodiments of this disclosure. A fluid distribution network may be a water distribution network, an oil distribution network, a gas distribution network, or a sewer distribution network. It is noted that any distribution network that transfers some fluid in any form through a network of pipes, channels, and/or any other conduits or mediums can be used to capture excess energy. The term energy can include, but is not limited to, mechanical energy, electrical energy, thermal energy, hydraulic energy, chemical energy, molecular energy, kinetic energy, and the likes.

Computer 102 of FIG. 1 may be configured to implement the steps of FIG. 2. In general, the method shown in FIG. 2 allows a user, among other things, to access geographical information, shown in step 10. The geographical information may be in various formats, including but not limited to, spreadsheets, tables, CAD files, and/or maps. These files may be stored on a relational database, an ODBC database, or a computer readable file and may be accessed using a terminal device coupled to a server storing the database or via an Internet connection. The geographical information may be provided by software programs such as, but not limited to, civil engineering software and/or hydrology methodology software. Alternatively, the geographical information may be downloaded from a server and may be accessed locally. In other embodiments, the geographical information may be accessed manually, e.g., reviewing information entered manually or printed from the various databases or software program listed above.

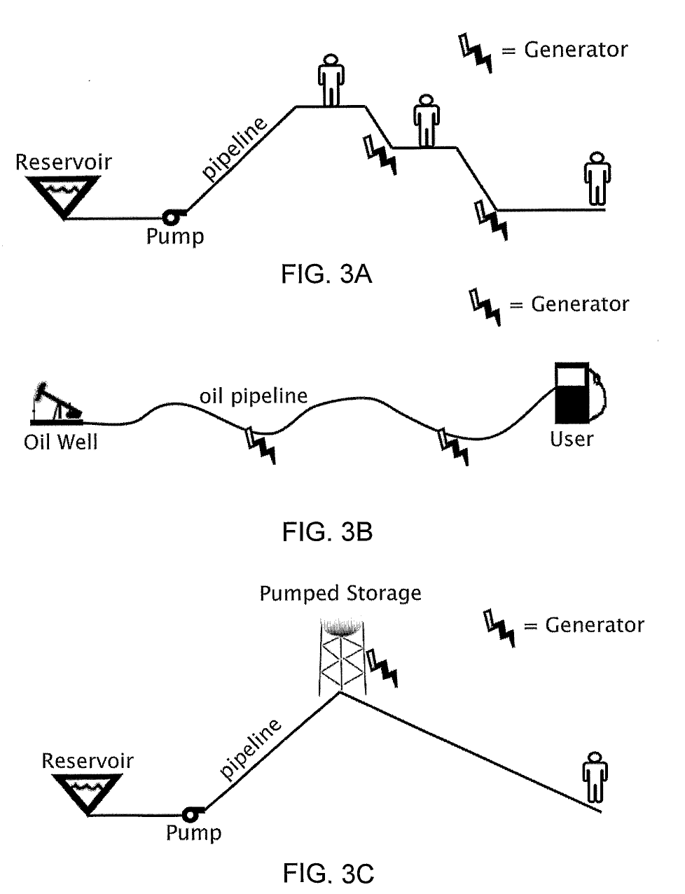

In step 20, the geographical information attained in step 10 may be analyzed to determine at least one location within the fluid distribution network to capture excess energy. In one embodiment, the geographical information may include, but is not limited to, information pertaining to a terrain of a region, location of a fluid distribution network, e.g., a city or town's layout of the infrastructure, the components of a fluid distribution network, attributes of the fluid distribution network, demographics, topography, zoning, emergency equipment, and/or local utility infrastructure data. For example, to determine a location to capture excess energy, the geographical information regarding the terrain of the region and the location of the fluid distribution network may be used to locate a slope in the terrain and/or fluid distribution network. As the slope declines in the terrain and fluid distribution network, e.g., a change in elevation from a higher elevation to a lower elevation, the software may determine at least one location where energy can be captured, as seen in FIGS. 3A and 3B. As noted above, gravity may increase the momentum of the flow of a fluid through the distribution network. The software executed on computer 102 in FIG. 1 may be configured to analyze the location where the maximum momentum occurs and determine the location(s) where energy can be captured without negative impact or with minimal negative impact.

In another example, the geographical information may include data where pumping stations are located throughout the distribution network. As noted above, artificial pumping, such as using electricity to run a pump, can also increase the pressure and the flow rate of the fluid. As such, the software that may be executed on computer 102 in FIG. 1 may be configured to determine the location(s) to capture excess energy in relation to a pumping station, as seen in FIG. 3C.

Step 30 provides for calculating an amount of energy recoverable at the location(s) identified in step 20, using, for example, Eq. 1 and Eq. 2. In one embodiment, the amount of energy recoverable may be determined for one location or a few locations determined in step 20. Alternatively, step 30 may provide for calculating the amount of energy recoverable for an entire fluid distribution network or any portions thereof.

In step 40, a cost associated with placing a power recovery system in at least one identified location may be calculated. The cost may include, but it is not limited to, cost associated with operation, installation, labor, maintenance, and/or upgrade and upkeep. Additionally, replacement parts, licensing fees, royalty costs, and/or any other type of costs associated with placing a generator in the fluid distribution network may be calculated. The calculations from both step 30 and 40 may be used to provide a cost/benefit analysis in step 50. This allows for those interested to determine whether or not placing a power recovery system in a fluid distribution network is beneficial and may also provide analysis on the impact on the quality of service associated with the fluid distribution network. Further, it provides guidance about where to place the one or more power recovery systems including generators within the network to optimize the benefits. This may include, without limitation, placing the one or more power recovery system in some of the locations identified and not at all locations. Alternatively, the analysis may conclude that the placement of a power recovery system at each identified location is most beneficial. It is noted that other cost and benefits may also be provided in step 50.

Upon determining at what location(s) a power recovery system is to be placed, step 60 provides for determining the type of power recovery system to include. This may include determining the type of turbine, piston, piezoelectric material, generator, and other components. In one embodiment, the turbine may be an impulse turbine. Alternatively, the turbine may be a reaction turbine. It is noted that for a fluid distribution network with two or more locations for which excess energy can be captured, one type of power recovery system may be placed at each location. In some embodiments, a different power recovery system may be placed at each location, e.g., at a first location, a power recovery system including an impulse turbine may be used and at a second location, a power recovery system including a reaction turbine may be used.

In addition to or alternatively, step 60 may also determine the type of power recovery system based on characteristics of the location. In some embodiments, characteristics of the location include, but are not limited to, the diameter, flow rate, elevation, slope, peak demand, head pressure, a distance, or proximity to other power system, and the like. Further, other considerations such as the physical layout of a power recovery system in the fluid distribution network may be analyzed. For example, the orientation of the power system, the volume of fluid flow through the power system, the appropriate fluid pressure on the power system, and/or the connection of the power recovery system to the fluid distribution network may be taken into account when determining the appropriate power recovery system for a location within a fluid distribution network.

The following examples are included to demonstrate embodiments of the invention. It should be appreciated by those of ordinary skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

A city, such as Austin, Tex., with a population of over 800,000 people is serviced by a single water utility company providing water pressure varying between 35 and 200 psi with approximately 160 million gallons of water per day flowing throughout the city. The city of Austin has a topography that varies greatly in elevation. If 10 percent of the water flow is converted into electricity, using the embodiments disclosed in this disclosure, the conversion could provide approximately 12 Megawatts of power, which can supply energy to over 30,000 households. The following example illustrates steps for determining optimal location(s) within a fluid distribution network for recovering the energy, while also providing cost benefit analysis for implementing a system to recover the energy.

### Receiving Geographical Information

In order to analyze the amount of energy and the cost of recovering the energy from a fluid distribution network, a software program may be used. The software program may be adapted to receive, among other things, geographical information. In one embodiment, the software may download the data from a database. Alternatively, the geographical information can be manually input into the software via a graphical user interface, command line prompt, or the like. Different categories of geographical information may be used to determine the site(s) or location(s) within the fluid distribution network that may be used to capture excess energy.

In one embodiment, an infrastructure component category may be received by the software. The infrastructure component category may include data about the pipes, valves, storage facilities, pumps, meters, and other components of the fluid distribution network. Additionally, the attributes of the components, including, without limitation, the material, dimension, elevation, hydraulic grade line (HGL), energy grade line (EGL), coordinate locations, age, condition, capacity, costs, and others may be used in the analysis. Aside from the components of the network, data related to the functionality of the network may also be provided. The functionality may include, among others, load or demand data, flow capacity, existing demand, future demand, demographics, zoning information, and/or the pressure zones. Further requirements, such as emergency safety requirements, minimum level of service, fluid quality, and/or safety of the fluid distribution network may also be provided.

In some embodiments, the format of the input information may need to be converted. This may be due to the different sources that can be used to attain the appropriate geographical information. For example, some geographical information may report pressure in gallons per minute, while others may report pressure in cubic feet per minute. As such, to accommodate numerous formats or standards, the software program may convert any of the above geographical information into a compatible and consistent format. Also, in some embodiments, different GIS may be used to attain all the necessary information prior to determining a location and cost benefit analysis and an overlap of information may occur. In some embodiments, the software may optimize the data received by removing redundancies, eliminating data associated with irrelevant components.

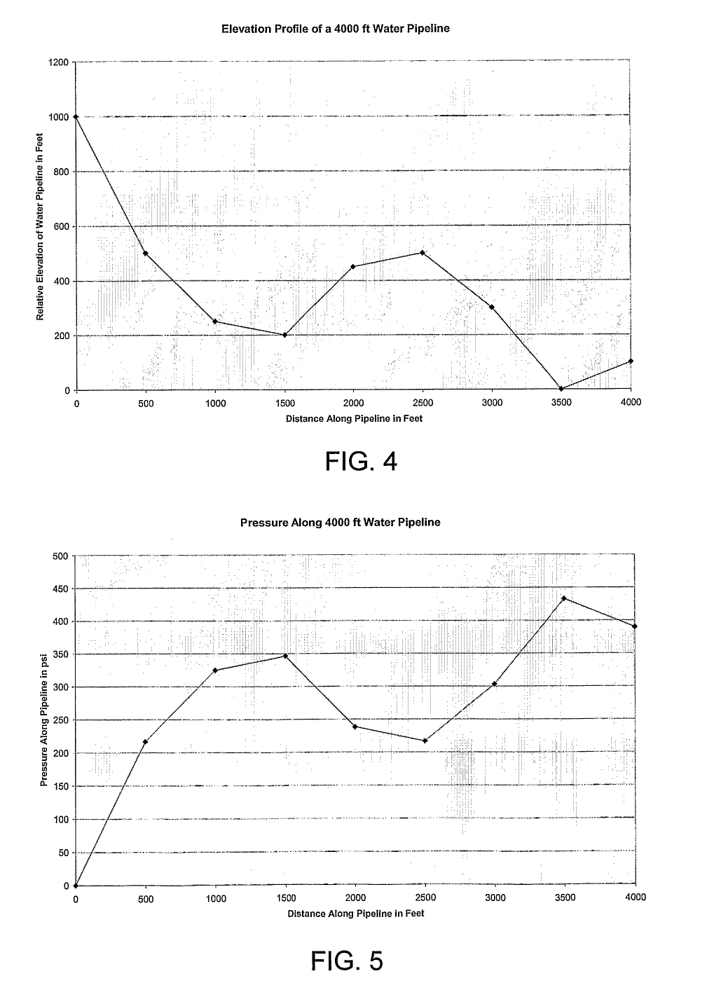

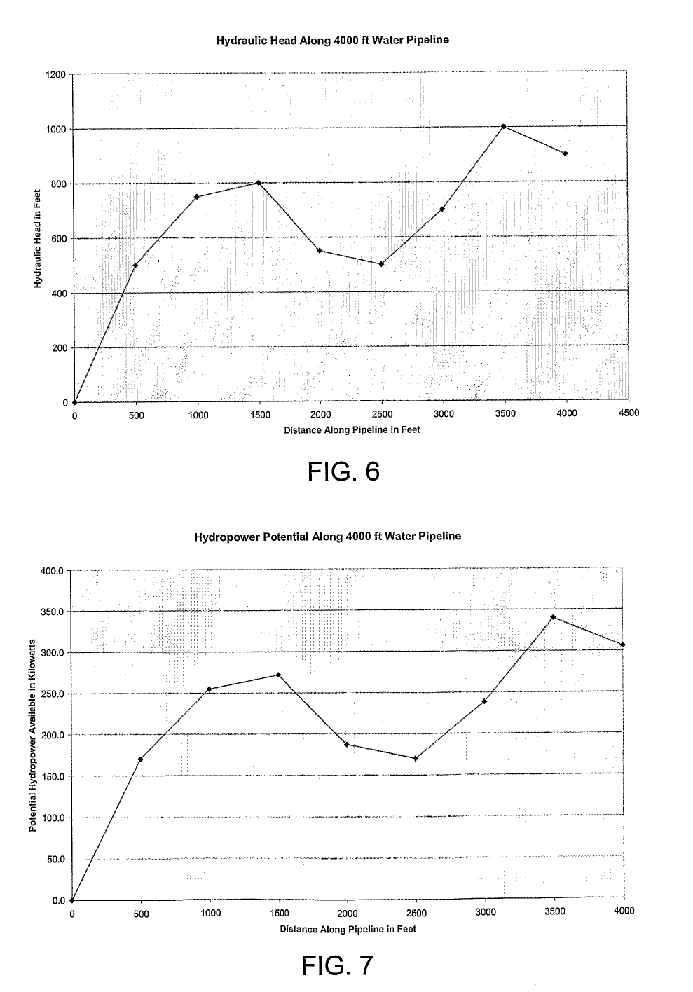

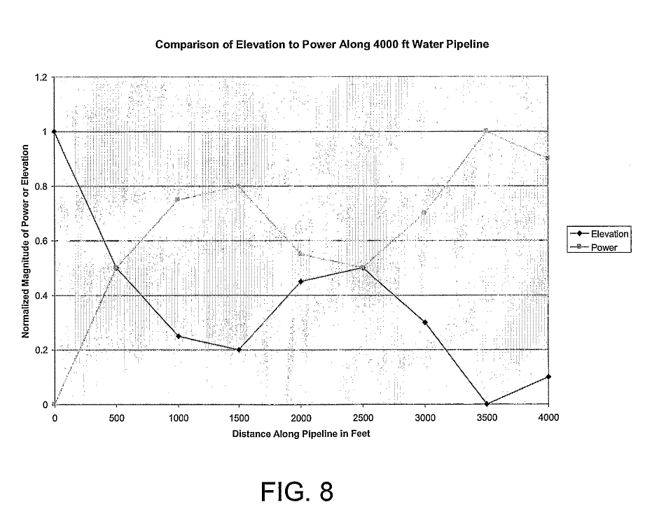

Upon receiving and standardizing the geographical information, the software program may analyze the information on a particular fluid distribution network and may provide analysis of the network to a user, as seen in FIGS. 4-8. For example, FIG. 4 shows a graph showing the elevation profile of a 4000 ft. water pipeline. This analysis of the elevation may provide insight for optimal locations within the fluid distribution network to place a power recovery system. Similarly, referring to FIGS. 5-7, a graph showing the pressure of the fluid movement, the hydraulic head, and the hydropower potential along the 4000 ft. water pipeline is provided, respectively and may provide information as to the optimal location(s) for energy recovery. In one embodiment, the potential power recovered at the different locations within the pipe may be compared with the graphs shown in FIGS. 4-7. For example, FIG. 8 compares the elevation (FIG. 4) and the potential power recovery along the pipeline. As seen at 1500 feet and at 3500 feet, the potential power recovered reaches a peak due to the decline in the elevation and thus, providing the maximum momentum of fluid flow. Each of these graphs, along with other factors, may be used by the software program to determine the locations within a fluid distribution network as described below. It is noted that the above steps may be performed in an automated manner. For example, the software program may be configured to automatically retrieve geographical information related to a location of interest and perform the calculations and site analysis, and output results as seen in FIGS. 4-8.

### Site Analysis

Different criteria used in selecting different locations within a fluid distribution network may be predefined and loaded into the software. These criteria allow for the customization of an individual fluid distribution network based on the geographical information obtained. For example, the mechanical requirements of the fluid distribution network, including, but not limited to, the flow rate, the condition of the pipelines, the proximity to an electrical grid, and other physical criteria can vary from one fluid distribution network to the next. Additionally, economic requirements including construction costs, licensing, system cost, and the like may vary from project to project, and thus, budget criteria may be uploaded into the software to define one or more parameters that affect optimization. The production requirement, e.g., the type of power generated and its intended use may also be criteria in the selection of different locations/sites. For example, to capture excess energy and output mechanical energy may require a different system than electrical energy. Further, the output energy amount (in kilowatts, for example) may vary, and as such, the criteria for the production of energy may be loaded into the software. It is noted that other criteria such as, but not limited to, storage or immediate use of the capture energy, may also be loaded into the software for consideration.

Upon determining the set of criteria for a particular location, the software program, using the geographical information attained, may automatically determine potential sites to place one or more generators to capture energy. This may include identifying high potential energy locations and/or identifying locations where the energy potential is the highest. At these identified locations, the software program may calculate the potential energy and may rank the locations based on geographical information involving flow rate and/or head pressure. The following table details an example of calculations that may be involved in identifying potential points for energy extraction in a pressure pipeline such as in a typical municipal water distribution system.

TABLE 1
Calculations for Determining Locations for Capturing Energy within a Fluid Distribution
Network
Pipe Characteristics

| | |
|---|---|
| Diameter (in) | 12 |
| Flow (gpm) | 1800 |
| Flow (cft/s) | 4.010427 |
| Velocity (ft/s) | 5.11 |

Hydropower Calculation

P = (H × Q)/11.8
P = power in kilowatts; H = head in ft; Q = flow in cu.ft/s

Note: This formula is for approximation only and does not account for power loss due to
generator efficiency or pipe loss due to friction.

| Pipe | Distance | Elevation | Pressure | Head | Hydropower | | |
|---|---|---|---|---|---|---|---|
| Junction | (ft) | (ft) | (psi) | (ft) | Potential (kW) | Elevation | Power |
| 1 | 0 | 1000 | 0 | 0 | 0.0 | 1 | 0 |
| 2 | 500 | 500 | 217 | 500 | 169.9 | 0.5 | 0.5 |
| 3 | 1000 | 250 | 325 | 750 | 254.9 | 0.25 | 0.7499 |
| 4 | 1500 | 200 | 346 | 800 | 271.9 | 0.2 | 0.7999 |
| 5 | 2000 | 450 | 238 | 550 | 186.9 | 0.45 | 0.5499 |
| 6 | 2500 | 500 | 217 | 500 | 169.9 | 0.5 | 0.5 |
| 7 | 3000 | 300 | 303 | 700 | 237.9 | 0.3 | 0.6999 |
| 8 | 3500 | 0 | 433 | 1000 | 339.9 | 0 | 0.9999 |
| 9 | 4000 | 100 | 390 | 900 | 305.9 | 0.1 | 0.8999 |

The software program may also correct for friction losses, e.g., loss of pressure or energy due to friction. After the calculations are performed, the software program may eliminate locations that do not meet the set of pre-defined criteria.

### Power Recovery System Selection

Upon determining possible location(s) within a fluid distribution network, the software program may determine the type of power recovery system most well-suited for the location(s), including, without limitation, a hydroelectric generator, a turbine, a power converter, and other components. The power recovery system selection may depend on the geographical information attained and the possible power recovery calculations. In one embodiment, factors such as the head and flow characteristics of a fluid distribution network may be used to determine the type of power system. For example, the software program may use the geographical information to determine if the fluid distribution head and flow characteristics fall under one the following categories: low head-low flow, low head-high flow, high head-low flow, or high head-high flow. Additionally, characteristics such as efficiency (e.g., efficiency of the power extraction, conversion, distribution, utilization, transfer, and storage), reliability of the power recovery system, maintenance of the power recovery system, and/or the costs of the power recovery system may be used in determining the appropriate power recovery system for a particular location. The software program may also consider the intended type of power that needs to be generated. For example, characteristics such as electrical power, including high voltage AC/DC power, low voltage AC/DC power, high or low frequency power, mechanical power, thermal power, and the like may determine the type of power recovery system needed.

Additional components may also be considered. For example, the safety of adding a power recovery system may be a concern. The software program may analyze components such as surge tanks, valves, gates, redundancy to insure that the fluid distribution network provides an efficient service to its end-users while maintaining the highest degree of safety. The software program may also provide analysis for the addition of monitoring devices, control devices (throttles), bypass equipment, and the likes used in the maintenance of an upgraded fluid distribution network with power recovery systems.

After providing suggested power recovery systems for a fluid distribution network, the software program may perform testing for infrastructure conflicts. In one embodiment, the software may analyze, among other things, the proximity of the fluid distribution network to other utilities or other structures. This analysis may determine if the inclusion of the power recovery system would interfere with the operation of other needed utility or structures within the area.

In other embodiments, the software program may also determine environmental concerns, such as, but not limited to, damage to local environment upon adding the power recovery system. Additionally, for a water distribution network, the software may determine hazards imposed on the water supply if a power recovery system is included in the distribution network.

The software program may also provide impact studies, which may involve, for example, finding production and flow bottlenecks, insuring fire and emergency safety, testing future demand projections, and the likes. Each of the above analyses, along with the set of criteria for a fluid distribution network, determines the appropriate power recovery system for individual locations in a fluid distribution network. It is noted that different locations within one fluid distribution network may have the same power system. Alternatively, different power recovery systems may be used at different locations depending on the geographical information attained and analysis.

### Cost Benefit Analysis

The addition of a power recovery system can be a costly investment. As such, the software program can provide an economic analysis. In one embodiment, upon determining the number and type of power recovery system needed, the software program may generate a financial estimate for the components, labor, operation, and maintenance costs as well as licensing and/or royalty fees. The individual estimates may be competitive market rates that may be input into the software program. Alternatively, the software program may download information from a database or from internet sites.

Next, the software program may provide a benefit analysis. The benefit analysis may determine if implementing a system for recovering energy is feasible. For example, the analysis may include estimating monetary value of the energy if sold. Alternatively, the analysis may include estimating the value of using the energy generated. In some embodiments, the software program may provide a break-even analysis, e.g., the value of the energy if sold or recycled versus the costs of implementing the power recovery system as well as the maintenance and operation system. The break-even analysis may consider the costs of a routing system used to allocate the energy recycled from the fluid distribution network back to the fluid distribution network. This recycled energy may help aid in the operation of the fluid distribution network, such as pumping of fluids through pipes among other functions. Alternatively, the break-even analysis may consider the cost of a routing system needed to deliver recovered energy to an energy storage facility as well as the cost of storage.

The results of the analysis may be summarized and may include the location(s) within the fluid distribution network that may be used to recover energy, the type of power recovery system for each location, the power production estimates involved, and other recommendations. This data may be printed, displayed, and/or exported in any format known in the art.

A software application using the techniques of this disclosure may be programmed in any computer language or script known in the art including but not limited to BASIC, FORTRAN, PASCAL, C, C++, C#, JAVA, HTML, XML, or the like. The application may be a stand-alone application, network based, and particularly, internet based to allow easy, remote access. The application may be run on a personal computer, personal digital assistant (PDA), or any other computing mechanism. Content from the application may be pushed to one or more portable devices as is known in the art.

With the benefit of the present disclosure, those having ordinary skill in the art will comprehend that techniques claimed here and described above may be modified and applied to a number of additional, different applications, achieving the same or a similar result. For example, any information presented to a user can be presented in text and/or graphic format. For example, one or more graphs, charts, clip-art, videos, animations, hierarchy trees, etc. may be used in addition to, or instead of the text and numerical data shown in the figures and described here. The claims attached here cover all modifications that fall within the scope and spirit of this disclosure.

### REFERENCES

The following references are each incorporated herein by reference.

Allan, In: Modeling of Pumped Storage and Hydropower Potential Within Water Supply Networks, Centre for Renewable Energy Systems techn., Loughborough University, UK, 2001.

City of Boulder, Colorado In: Wasted Water Pressure and Potential Energy Generation: A Feasibility Study of Hydroelectric Potential in Part of the Domestic Water System of Boulder; Colorado, Colorado Project/Tip, 1980.

Computer Applications In: Hydraulic Engineering: Connecting Theory to Practice, 5th Ed., Haestad Methods, Inc., 2002.

de Jonge et al., In: Application of Geographic Information in Hydrology and Water Resources Management, Proc. of the Vienna Conf., IAHS Pub. 235:307-313, 1996.

Durrans, In: Stormwater Conveyance Modeling and Design, Haestad Methods, 1^{st} Ed., 2003.

French and Widden, Proc. Instn. Mech. Engrs., 215(A):223-230, 2001.

Griffin, Proc. Instn. Mech. Engrs., 214(A):41-51, 2000.

IEA/OECD In: Small-Scale Hydro Within a Municipal Water Supply System, CADDET Renewable Energy Technical Brochure No. 130.

James, J. AWWA, 90(7):74-79, 1998.

James, J. Executive Summary, 90:1-2, 1998.

McCorlay, In: GIS Applications at Bergen Water, Bergen Munici. Waterwors, Postboks 805, Norway, 2000.

Muselli et al, Applied. Energy, 63:141-160, 1999.

Paish, Proc. Instn. Mech. Engrs., 216(A):31-40, 2002.

PCT Appln. WO 01/53698

PCT Appln. WO 01/53698

PCT Appln. WO 02/10553

PCT Appln. WO 02/10553

PCT Appln. WO 03/057998

PCT Appln. WO 03/083290

PCT Appln. WO 97/01018

PCT Appln. WO 97/01018

U.S. Dept of Energy, In: Hydropower Potential of the U.S. with Emiphasis on Low Head/Low Power Resources, DOE/ID-11111, Energy Efficiency and renewable Energy-Wind and Hydropower Technologies, 2003.

U.S. Pat. No. 1,010,608

U.S. Pat. No. 1,010,609

U.S. Pat. No. 2,487,947

U.S. Pat. No. 2,487,947

U.S. Pat. No. 4,057,736

U.S. Pat. No. 4,122,381

U.S. Pat. No. 4,122,381

U.S. Pat. No. 4,134,024

U.S. Pat. No. 4,134,024

U.S. Pat. No. 4,208,873

U.S. Pat. No. 4,208,873

U.S. Pat. No. 4,272,686

U.S. Pat. No. 4,352,025

U.S. Pat. No. 4,352,025

U.S. Pat. No. 4,403,154

U.S. Pat. No. 4,403,154

U.S. Pat. No. 4,443,707

U.S. Pat. No. 4,443,707

U.S. Pat. No. 4,488,055

U.S. Pat. No. 4,496,845

U.S. Pat. No. 4,731,545

U.S. Pat. No. 4,740,711

U.S. Pat. No. 4,740,711

U.S. Pat. No. 4,742,457

U.S. Pat. No. 4,873,830

U.S. Pat. No. 4,873,830

U.S. Pat. No. 4,918,369

U.S. Pat. No. 4,923,368

U.S. Pat. No. 5,007,241

U.S. Pat. No. 5,043,592

U.S. Pat. No. 5,362,987

U.S. Pat. No. 5,362,987

U.S. Pat. No. 5,863,188

U.S. Pat. No. 6,023,986

U.S. Pat. No. 6,194,191

U.S. Pat. No. 6,194,815

U.S. Pat. No. 6,309,179

U.S. Pat. No. 6,509,652

U.S. Patent Appl. Pub. 2001/0022085

U.S. Patent Appl. Pub. 2002/0180216

U.S. Patent Appl. Pub. 2003/0046931

U.S. Patent Appl. Pub. 2003/0218338

U.S. Patent Appln. Pub. 2002/0096887

U.S. Patent Appln. Pub. 2002/0096887

Walski et al., In: Advanced Water Distribution Modeling and Management, Haestad Methods, 1^{st} Ed., 2003.

1. A computer readable medium comprising computer executable instructions for:
retrieving geographical information associated with a fluid distribution network;
performing one or more calculations using the geographical information to determine energy recovery values at different locations within the fluid distribution network; and
identifying one or more locations within the fluid distribution network to place a power recovery system for recovering energy based on the one or more calculations.

2. The computer readable medium of claim 1, further comprising instructions for calculating a cost associated with placing the power recovery system at a location.

3. The computer readable medium of claim 2, farther comprising instructions for providing a cost/benefit analysis associated with the placement of the power recovery system.

4. The computer readable medium of claim 1, further comprising instructions for determining al type of power recovery system.

5. The computer readable medium of claim 4, further comprising instructions for determining a diameter, flow-rate, elevation, or slope of the power recovery system based on geographical information associated with a location.

6. The computer readable medium of claim 5, where the geographical information associated with the location comprises slope information.

7. The computer readable medium of claim 4, further comprising instructions for determining a type of generator based on peak demand or head pressure associated with a location.

8. The computer readable medium of claim 1, where the fluid distribution network comprises a water distribution network, an oil distribution network, a gas distribution network or a sewage distribution network.

9. The computer readable medium of claim 1, where the power recovery system comprises a hydroelectric generator.

10. The computer readable medium of claim 1, where the geographical information comprises GIS data.

11. The computer readable medium of claim 10, where the GIS data comprises GIS data in ESRI shape file format.

12. The computer readable medium of claim 1, where retrieving geographical information comprises retrieving geographical information through GIS software, ArcGIS software, a spreadsheet, a CAD file, or a map.

13. A method comprising:
retrieving geographical information associated with a fluid distribution network;
performing one or more calculations using the geographical information to determine energy recovery values at different locations within the fluid distribution network;
identifying one or more locations within the fluid distribution network to place a power recovery system for recovering energy based on the one or more calculations; and
generating energy with the power recovery system.

14. The method of claim 13, further comprising using the generated energy for an energy need within the fluid distribution network.

15. The method of claim 14, where the energy need comprises energy needed to pump fluids within the fluid distribution network.

16. The method of claim 14, further comprising using the generated energy for an energy need outside the fluid distribution network.

17. The method of claim 14, further comprising storing the generated energy for future use.

18. A program storage device readable by a machine, tangibly embodying a program of instructions executable by the machine to perform the function of claim 1.

19. A system comprising:
a fluid distribution network;
a computer configured to:
retrieve geographical information associated with the fluid distribution network;
perform one or more calculations using the geographical information to determine energy recovery values at different locations within the fluid distribution network; and
identify one or more locations within the fluid distribution network to place a generator for recovering energy based on the one or more calculations; and
a power recovery system configured to recover energy at or around an identified location.

20. The system of claim 19, further comprising a routing system coupled to the power recovery system configured to allocate energy generated from the power recovery system within the fluid distribution network.

21. The system of claim 20, where the routing system allocates energy generated from the power recovery system to outside of the fluid distribution network.

22. The system of claim 20, where the routing system allocates energy generated from the power recovery system to an energy storage facility.
